(19) United States
(12) Patent Application Publication
(10) Pub. No.: US 2009/0171666 A1
(43) Pub. Date: Jul. 2, 2009

(54) Interpolation Device, Audio Reproduction Device, Interpolation Method, and Interpolation Program

(75) Inventor: Hideki Ohtsu, Saitama (JP)

Correspondence Address: ERIC ROBINSON, PMB 955, 21010 SOUTHBANK ST., POTOMAC FALLS, VA, 20165, US

(73) Assignee: Kabushiki Kaisha Kenwood, Hachiouji-shi, Tokyo (JP)

(21) Appl. No.: 12/085,356

(22) PCT Filed: Nov. 29, 2006
(86) PCT No.: PCT/JP2006/324318

§ 371 Date: May 22, 2008

(30) Foreign Application Priority Data
Nov. 30, 2005 (JP) 2005-345961

(51) Int. Cl. G10L 13/00

(52) U.S. Cl. 704/265; 704/E13.001

(57) ABSTRACT

An interpolation device (4) includes a band extraction high-pass filter (11) for extracting a frequency component of a predetermined lower limit frequency or above from reproduction data obtained by digitizing an audio waveform signal; a multiplier (13) for frequency-shifting the frequency component extracted by the band extraction high-pass filter (11); lower side wave band suppression high-pass filter (14) suppressing the frequency component of the lower side wave band in the frequency component subjected to frequency shift by the multiplier (13); and an adder (17) for adding the frequency component after suppression by the lower side wave band suppression high-pass filter (14). It is possible to reduce the processing load.

### TECHNICAL FIELD

The present invention relates to an interpolation device, an audio reproduction device, an interpolation method, and an interpolation program.

### BACKGROUND ART

Japanese Patent Application Laid-Open No. 2002-171588 (claims, detailed description of the invention, drawings, and the like) discloses a signal interpolation device. The signal interpolation device has a filter for extracting components in a first band from interpolated signals, which are to be interpolated, a frequency converter for frequency-converting the components in the first band extracted by the filter into a second band at higher frequencies than the band the interpolated signals occupy and generating interpolation components, and an adding unit for generating an output signal representing the sum of the interpolation components generated by the frequency converter and the interpolated signals.

Such interpolation processing allows the signal interpolation device in Japanese Patent Application Laid-Open No. 2002-171588 to interpolate components in harmony with original sound components, and to interpolate frequency components so as to provide sound with quality higher than when noise components are interpolated, for example.

### DISCLOSURE OF THE INVENTION

However, in addition to a variable band pass filter (BPF), which is the filter described above, the signal interpolation device of Patent Document 1 needs a variable high-pass filter (HPF) in order to generate favorable interpolation components. Therefore, the overall order of a filter required to generate the interpolation components will be inevitably increased. Accordingly, the processing load of the signal interpolation device cannot be decreased to a certain level or less, or needs a delay unit for delaying interpolated signals in order to synchronize the phases of the interpolated signals and the interpolation components.

As a result of earnest studies, the present inventors became strongly convinced that reproduction data obtained by digitizing an audio waveform signal has already been band-limited at high frequencies due to its digitization, discovered that the overall order of a filter could be reduced by suitably taking advantage of this fact, and thus reached completion of the present invention.

An object of the present invention is to obtain an interpolation device, an audio reproduction device, an interpolation method, and an interpolation program that can reduce the processing load.

The interpolation device according to the present invention has a band extraction high-pass filter for extracting frequency components at a predetermined lower limit frequency or greater from reproduction data obtained by digitizing an audio waveform signal; a multiplier for subjecting the frequency components extracted by the band extraction high-pass filter to frequency shift; a lower side wave band suppressed high-pass filter for suppressing the frequency components in a lower side wave band in the frequency components subjected to frequency shift by the multiplier; and an adder for adding the frequency components after suppression by the lower side wave band suppressed high-pass filter to the frequency components of the reproduction data.

In addition to the configuration of the present invention described above, in the interpolation device according to the present invention, the band extraction high-pass filter and the lower side wave band suppressed high-pass filter are made up of an IIR filter, and the reproduction data to be supplied to the band extraction high-pass filter is supplied to the adder without delay.

In addition to each configuration of the present invention described above, the interpolation device according to the present invention has a setting value table for storing setting values according to higher limit frequencies for reproduction of the reproduction data to be supplied to the band extraction high-pass filter; specifying means for specifying a higher limit frequency for reproduction of the reproduction data to be supplied to the band extraction high-pass filter; and setting means for reading thereinto, from the setting value table, the setting value corresponding to the higher limit frequency for reproduction specified by the specifying means, and setting a predetermined lower limit frequency of the band extraction high-pass filter, the width of the frequency shift by the multiplier, and frequency components suppressed by the lower side wave band suppressed high-pass filter.

In addition to each configuration of the present invention described above, the interpolation device according to the present invention has a setting value table for storing a setting value for each range of higher limit frequencies for reproduction of the reproduction data to be supplied to the band extraction high-pass filter; specifying means for specifying a higher limit frequency for reproduction of the reproduction data to be supplied to the band extraction high-pass filter; and setting means for reading thereinto, from the setting value table, the setting value in a range including the higher limit frequency for reproduction specified by the specifying means, and setting a predetermined lower limit frequency of the band extraction high-pass filter, the width of the frequency shift by the multiplier, and frequency components suppressed by the lower side wave band suppressed high-pass filter.

In addition to each configuration of the present invention described above, in the interpolation device according to the present invention, the ranges of the higher limit frequencies for reproduction of the reproduction data above 8 kHz in the setting value table are 8 kHz or greater but less than 10 kHz, 10 kHz or greater but less than 12 kHz, 12 kHz or greater but less than 14 kHz, 14 kHz or greater but less than 17 kHz, and 17 kHz or greater.

The audio reproduction device according to the present invention has the interpolation device according to each configuration of the present invention described above, and a decoder for supplying reproduction data having a higher limit frequency for reproduction that is lower than the Nyquist frequency to the interpolation device.

Another audio reproduction device according to the present invention has the interpolation device according to each configuration of the present invention described above, and a decoder for generating from reproduction data, which is non-reciprocally compressed so that high frequency components are removed, the reproduction data to be supplied to the interpolation device.

The interpolation method according to the present invention has steps of: extracting frequency components at a predetermined lower limit frequency or greater from reproduction data obtained by digitizing an audio waveform signal; subjecting the extracted frequency components to frequency shift; suppressing the frequency components in a lower side wave band in the frequency components subjected to frequency shift; and adding the frequency components after the suppression to the frequency components of the reproduction data.

The interpolation program according to the present invention causes a computer to execute steps of: extracting frequency components at a predetermined lower limit frequency or greater from reproduction data obtained by digitizing an audio waveform signal; subjecting the extracted frequency components to frequency shift; suppressing the frequency components in a lower side wave band in the frequency components subjected to frequency shift; and adding the frequency components after the suppression to the frequency components of the reproduction data.

The present invention can reduce the processing load.

### BRIEF DESCRIPTION OF THE DRAWINGS

FIG. 1 is a block diagram showing an audio reproduction device according to an embodiment of the present invention;

FIG. 2 is a block diagram showing an interpolation unit in FIG. 1;

FIG. 3 is a diagram showing a frequency characteristic curve of a 2 order digital filter;

FIG. 4 is an explanatory diagram showing the contents of a setting value table;

FIG. 5 is an example of a list of higher limit frequencies for reproduction of reproduction data encoded in an MP3 format;

FIG. 6 is a diagram schematically showing the change of a frequency distribution at the interpolation unit; and

FIG. 7 is a block diagram showing the configuration of the interpolation unit where a band extraction BPF is used.

### DESCRIPTION OF SYMBOLS

1 audio reproduction device
2 hard disk drive (HDD)
3 decoder
4 interpolation unit
5 audio amplifier
6 loud speaker
8 digital signal processor chip
11 band extraction high-pass filter
12 oscillator
13 multiplier
14 lower side wave band suppressed HPF
15 interpolation component attenuator
16 main attenuator
17 adder
18 setting value table
19 parameter setting unit
31 band extraction BPF
32 delay unit

### BEST MODES FOR CARRYING OUT THE INVENTION

An interpolation device, an audio reproduction device, an interpolation method, and an interpolation program according to an embodiment of the present invention will now be described with reference to the drawings. Note that the interpolation device and the interpolation program are described as part of the configuration of the audio reproduction device. The interpolation method is described as part of the operation of the audio reproduction device.

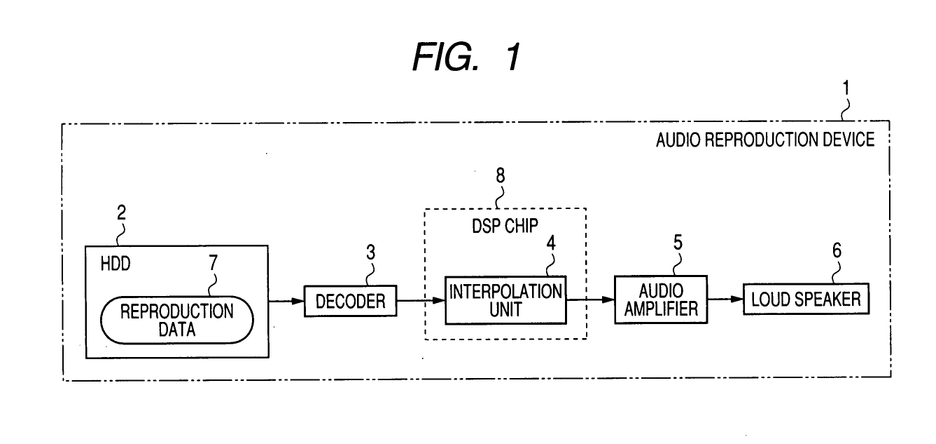

FIG. 1 is a block diagram showing an audio reproduction device 1 according to an embodiment of the present invention. The audio reproduction device 1 has a hard disk drive (HDD) 2, a decoder 3, an interpolation unit 4 serving as an interpolation device, an audio amplifier 5 and a loud speaker 6, and reproduces audio based on audio data. As the audio reproduction device 1 includes, for example, a portable audio player, Audio Visual (AV) equipment, a car audio system, a car navigation system, a reproduction device such as a CD and a DVD, a cellular phone, a personal digital assistant such as a PDA, and a personal computer having an audio output function.

The hard disk drive 2 stores reproduction data 7.

The reproduction data 7 is original sound data obtained by sampling, at a period based on a predetermined sampling frequency, analog audio waveform signals, which can be supplied to the loud speaker 6 and the audio amplifier 5, or data obtained by encoding this original sound data. The original sound data includes linear PCM data, for example. There are encoding by non-reciprocal compression, and encoding by reciprocal compression.

There are methods of encoding original sound data, for example, using the MPEG1 Audio Layer-3 (MP3) format, or using the Advanced Audio Codec (AAC) format. In these encoding methods, high frequency components contained in the original sound data are removed for compression and encoding. Therefore, when the reproduction data 7 compressed by these encoding methods is reproduced, the frequency of the higher limit of the frequency components (hereinafter referred to as higher limit frequency for reproduction) becomes lower than that of the Nyquist frequency. The original sound data is non-reciprocally compressed. The reproduction data 7 has a high frequency silent band where there is no frequency component between the higher limit frequency for reproduction and the Nyquist frequency.

The decoder 3 decodes the reproduction data 7. The decoder 3 generates decoded data whose value varies at each sampling period.

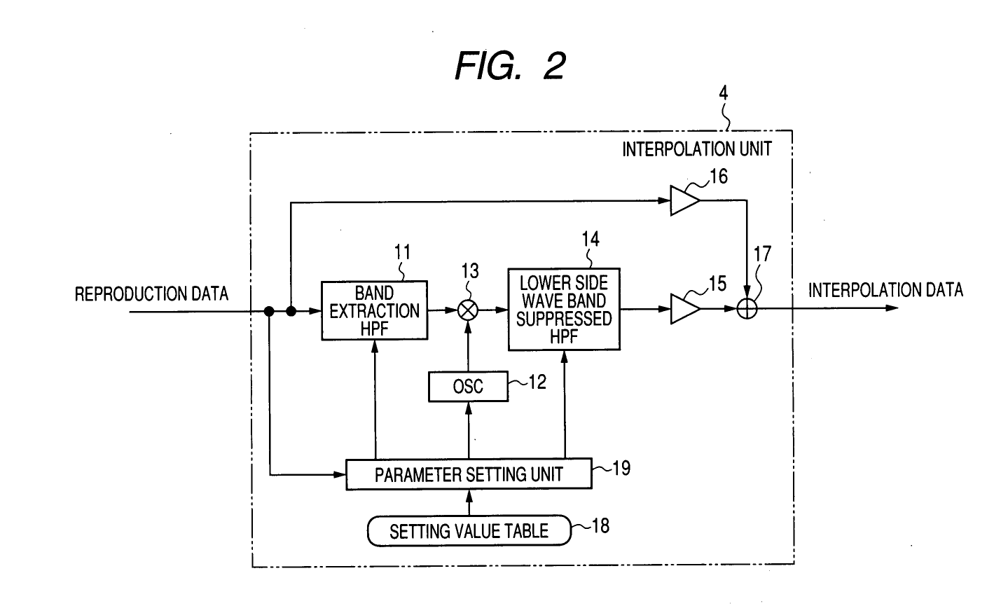

FIG. 2 is a block diagram showing the interpolation unit 4 in FIG. 1. The interpolation unit 4 has a band extraction High-Pass Filter (HPF) 11, an oscillator (OSC) 12, a multiplier 13, a lower side wave band suppressed HPF 14, an interpolation component attenuator 15, a main attenuator 16, and an adder 17.

Note that the interpolation unit 4 as shown in FIG. 2 is realized in such a way that, as shown in FIG. 1, a central processing unit, not shown, of a Digital Signal Processor chip (DSP) 8 executes a signal interpolation program, not shown. The signal interpolation program may be provided from a computer readable storage medium such as a Compact Disc Read Only Memory (CD-ROM), and a transmission medium such as the Internet and a telephone communication network. Further, the interpolation unit 4 may be realized at a microcomputer chip, not at a DSP chip 8.

The band extraction HPF 11 extracts the frequency components at the set lower limit frequency or greater from the reproduction data 7 to be supplied to the interpolation unit 4 from the decoder 3.

The band extraction HPF 11 can be realized by a digital filter such as an Infinite duration Impulse Response (IIR) filter, a Finite duration Impulse Response (FIR) filter, or the like, for example. In these digital filters, the reproduction data 7 and output data are held by delaying them by the order thereof. Then the digital filter extracts from the reproduction data 7 the frequency components at the set lower limit frequency or greater by adding and subtracting the reproduction data 7 and output data it holds, and reproduction data 7 to be newly entered, at set weighted proportions.

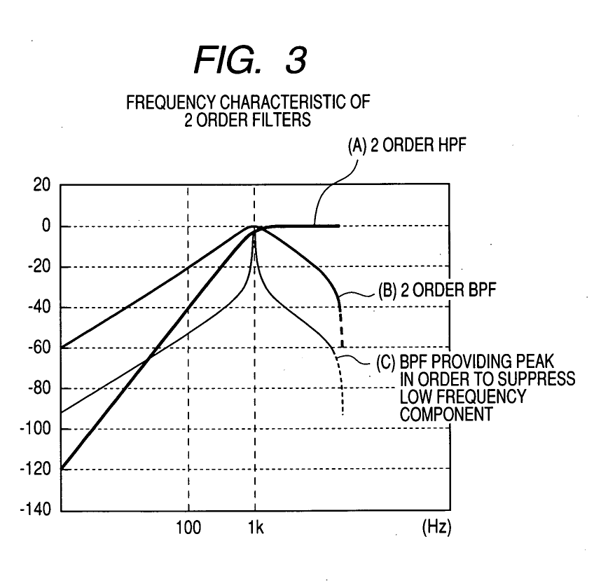

In the present embodiment, the band extraction HPF 11 is configured as a 2 order IIR filter. FIG. 3 is a diagram showing a frequency characteristic curve of a 2 order digital filter. A lateral axis represents a frequency, and a vertical axis represents an attenuation. A curve A is an example of the frequency characteristic curve of a 2 order high-pass filter when set to extract frequency components of approximately 1 kHz or greater. A curve B is an example of the frequency characteristic curve of a 2 order band pass filter when set to extract frequency components in a band centered on approximately 1 kHz. A curve C is an example of the frequency characteristic curve of a 2 order band pass filter having band extraction characteristics featuring a peak when set to extract frequency components in a band centered on approximately 1 kHz.

As is evident from the comparison between the curve A and the curve B, the 2 order high-pass filter suppresses the low frequency components more than the same order band pass filter. For example, a suppression effect of the 100 kHz frequency component by the 2 order band pass filter is about −20 dB. On the other hand, the suppression effect of the 2 order high-pass filter is as high as about −40 dB. When attempting to obtain in the 2 order band pass filter the same low frequency component suppression effect as the 2 order high-pass filter, the characteristics of the band pass filter become characteristics that are unsuitable as the band pass filter, having a peak near the central frequency as shown in the curve C. Therefore, although the details will be described later, the high-pass filter providing a sharp cutoff characteristic is used in the present embodiment.

The oscillator 12 generates oscillator data from a digitized waveform signal varying at a set constant frequency. Note that the oscillator data varies in synchronization with the reproduction data 7 to be supplied to the interpolation unit 4.

The multiplier 13 multiplies two supplied data. The data of the frequency components extracted by the band extraction HPF 11, and the oscillator data are supplied to the multiplier 13. The multiplier 13 multiplies these data, for example.

The lower side wave band suppressed HPF 14 extracts the frequency components at the set lower limit frequency or greater from the data of the frequency components supplied by the multiplier 13. Note that the lower side wave band suppressed HPF 14 may be realized by an IIR filter, an FIR filter, or the like, for example. The lower side wave band suppressed HPF 14 of the present embodiment may be a 2 order IIR filter, for example.

The interpolation component attenuator 15 and the main attenuator 16 adjust the amplitude of the data entered. The data of the frequency components suppressed by the lower side wave band suppressed HPF 14 is supplied to the interpolation component attenuator 15. The reproduction data 7 to be supplied to the interpolation unit 4 from the decoder 3 is supplied to the main attenuator 16.

The adder 17 adds the two supplied data. The data of the interpolation component whose amplitude is adjusted by the interpolation component attenuator 15, and the reproduction data 7 whose amplitude is adjusted by the main attenuator 16 are supplied to the adder 17.

The interpolation data generated by the adder 17 is supplied to the audio amplifier 5 in FIG. 1. The audio amplifier 5 generates an analog audio waveform signal based on the interpolation data, and outputs the signal to the loud speaker 6. The amplitude of the analog audio waveform signal varies according to the value of the interpolation data. The loud speaker 6 generates a sound wave by the supplied analog audio waveform signal.

Return to FIG. 2. In addition, the interpolation unit 4 has a setting value table 18, and a parameter setting unit 19 serving as specifying means and setting means. Note that the setting value table 18 may be stored in a storage unit, not shown, of the DSP chip 8 and the microcomputer chip.

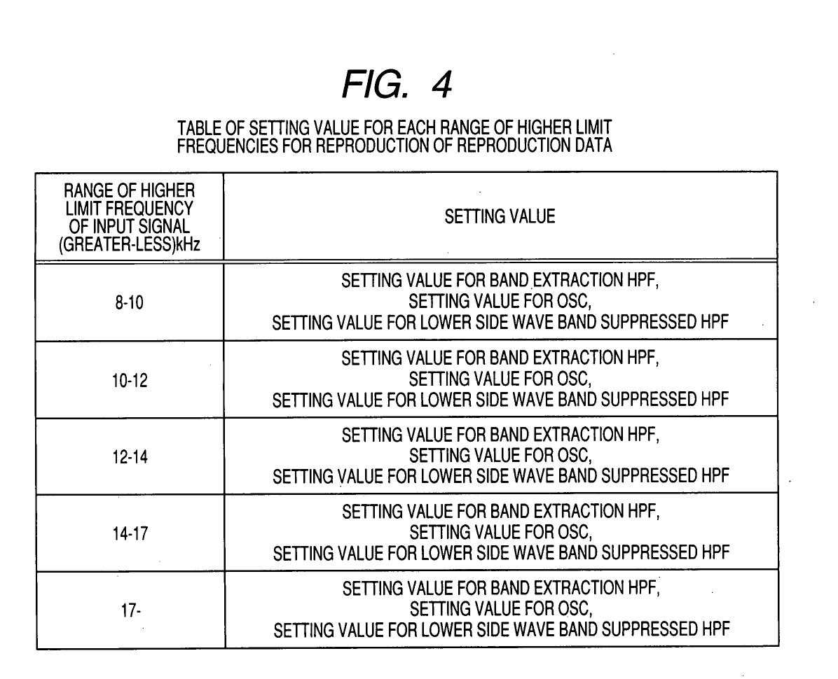

FIG. 4 is an explanatory diagram showing the contents of a setting value table 18. The setting value table 18 has a plurality of setting values. Each setting value has a setting value for the band extraction HPF 11, a setting value for the oscillator 12, and a setting value for the lower side wave band suppressed HPF 14, and is stored so as to correspond to a higher limit frequency for reproduction of the reproduction data 7. More specifically, in the setting value table 18, the higher limit frequencies for reproduction above 8 kHz are divided into five ranges; a range of 8 kHz or greater but less than 10 kHz, a range of 10 kHz or greater but less than 12 kHz, a range of 12 kHz or greater but less than 14 kHz, a range of 14 kHz or greater but less than 17 kHz, and a range of 17 kHz or greater, and a setting value is provided for each frequency range. As described above, by dividing the higher limit frequencies for reproduction of the reproduction data 7 to be entered in the interpolation unit 4 into a plurality of ranges, the setting value table 18 need not store an individual setting value for each higher limit frequency for reproduction of the reproduction data 7.

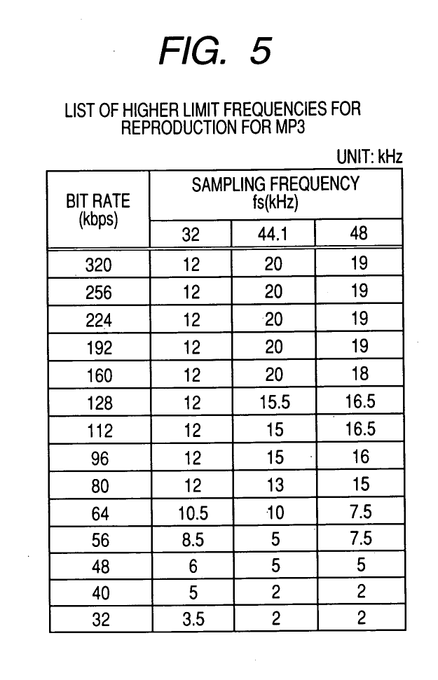

FIG. 5 is an example of a list of higher limit frequencies for reproduction of the reproduction data 7 encoded in an MP3 format. FIG. 5 lists the higher limit frequencies for reproduction of the reproduction data 7 having three types of sampling frequencies of 32 kHz, 44.1 kHz and 48 kHz, and bit rates of 32 to 320 kbps. For example, the higher limit frequency for reproduction of the reproduction data 7 with a sampling frequency of 32 kHz and a bit rate of 112 kbps is 12 kHz. The reproduction data 7 has the frequency components from 0 to 12 kHz, while the Nyquist frequency is 16 kHz. As described above, with non-reciprocal compression using an MP3 format, the higher limit frequencies for reproduction of the reproduction data 7 become lower than the Nyquist frequency.

In the list of FIG. 5, there are 13 types of reproduction data 7 with a higher limit frequency for reproduction of 8 kHz or greater by rounding off the second decimal. Therefore, if the setting value table 18 has an individual setting value for each higher limit frequency for reproduction of the reproduction data 7, 13 sets of setting value combinations have to be stored in the setting value table 18. On the other hand, division into five stages as shown in FIG. 4 allows the setting value table 18 to store only five sets of setting value combinations. The setting value combinations stored in the setting value table 18 can be half or less.

The parameter setting unit 19 selects a set of setting value combinations from the setting value table 18, and reads them thereinto. The parameter setting unit 19 performs setting processing on the band extraction HPF 11, the oscillator 12, and the lower side wave band suppressed HPF 14, based on the selected and read setting values.

Next, the operation of the audio reproduction device 1 having the above described configuration will be described.

The decoder 3 reads thereinto the reproduction data 7 from the hard disk drive 2. Note that the decoder 3 may read thereinto the reproduction data 7 of music selected by the operation of an input key, not shown, of the audio reproduction device 1 from the hard disk drive 2.

Further, the decoder 3 decodes the read reproduction data 7. The decoder 3 generates decoded data whose value varies at each sampling period. The decoder 3 supplies the generated decoded data to the interpolation unit 4.

When the decoded data is supplied to the interpolation unit 4, the parameter setting unit 19 analyzes the supplied decoded data, and specifies its higher limit frequency for reproduction. Note that the parameter setting unit 19 may obtain information about the decoded reproduction data 7 from the decoder 3 in addition to the decoded data, and specify its higher limit frequency for reproduction based on the obtained information. In this case, the parameter setting unit 19 may have a list of higher limit frequencies for reproduction as shown in FIG. 5, for example, and search the list with the obtained information and select from the list the higher limit frequency for reproduction matching or closest to the obtained information.

After specifying the higher limit frequency for reproduction of the decoded data supplied to the interpolation unit 4, the parameter setting unit 19 refers to the setting value table 18 in FIG. 4. Then, the parameter setting unit 19 reads thereinto a setting value corresponding to a range including the specified higher limit frequency for reproduction from the setting value table 18. For example, if the specified higher limit frequency for reproduction is 13 kHz, the parameter setting unit 19 reads thereinto the setting value on the third row from top of the setting value table 18 in FIG. 4.

After reading thereinto the setting value from the setting value table 18, the parameter setting unit 19 uses the setting value to perform setting processing on the band extraction HPF 11, the oscillator 12, and the lower side wave band suppressed HPF 14. More specifically, the setting unit 19 sets the predetermined lower limit frequency of the band extraction HPF 11, the width of the frequency shift by the multiplier 13, frequency components suppressed by the lower side wave band suppressed HPF 14, and the like.

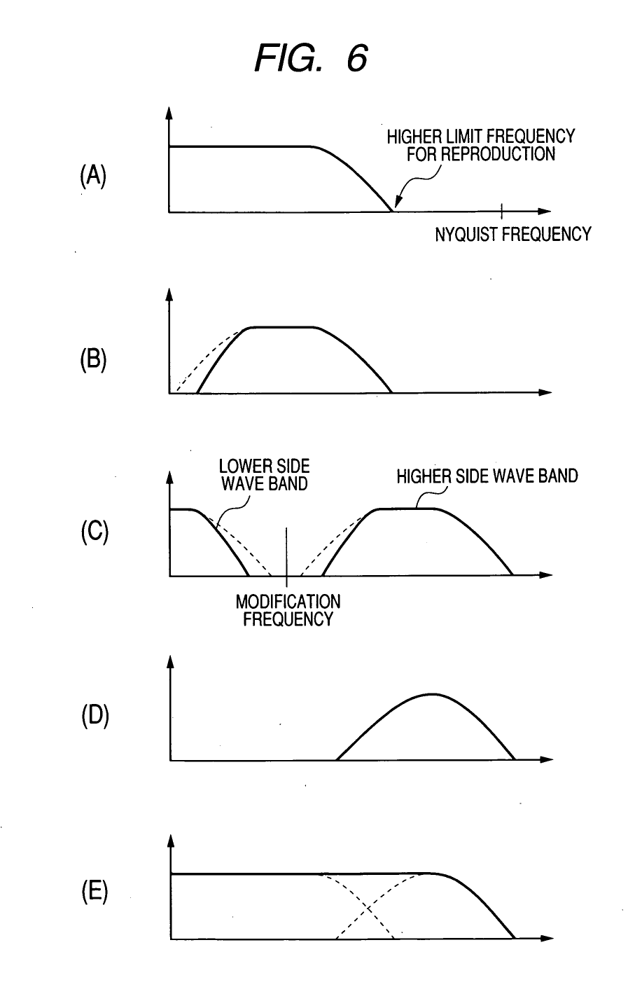

When the setting value is set by the parameter setting unit 19, the interpolation unit 4 starts interpolation processing based on the setting. FIG. 6 is a diagram schematically showing the change of a frequency distribution at the interpolation unit 4. FIG. 6(A) is the frequency distribution of the decoded data to be supplied to the interpolation unit 4. The higher limit frequencies for reproduction of the decoded data are lower than the Nyquist frequency. FIG. 6(B) is the frequency distribution of the data generated by the band extraction HPF 11. FIG. 6(C) is the frequency distribution of the data generated by the multiplier 13. FIG. 6(D) is the frequency distribution of the data generated by the lower side wave band suppressed HPF 14. FIG. 6(E) is the frequency distribution of the data generated by the adder 17. In each frequency distribution of FIG. 6, a lateral axis represents a frequency, and a vertical axis represents strength.

The band extraction HPF 11 extracts the frequency components at the set lower limit frequency or greater from the decoded data to be supplied to the interpolation unit 4. Thus, data having the frequency distribution shown in FIG. 6(B) is generated from the decoded data having the frequency distribution shown in FIG. 6(A).

The oscillator 12 generates oscillator data varying at a set constant frequency. The multiplier 13 multiplies the data having the frequency component in FIG. 6(B) extracted by the band extraction HPF 11 by the oscillator data. More specifically, the multiplier 13 modulates the amplitude of the data having the frequency component in FIG. 6(B) by the oscillator data.

With such multiplication by the multiplier 13, data having the frequency distribution shown in FIG. 6(C) is generated. In the frequency distribution in FIG. 6(C), two frequency distributions appear symmetrically, centered on the modulation frequency of the oscillator data. The distribution of the frequency lower than the modulation frequency is called a lower side wave band, and the distribution of the frequency higher than the modulation frequency is called a higher side wave band. The higher side wave band has the same distribution as the frequency distribution in FIG. 6(B). The higher side wave band has a frequency distribution resulting from shifting the frequency distribution in FIG. 6(B) to higher frequencies. The width of the frequency shift is the width of the frequency corresponding to the modulation frequency of the oscillator 12. In addition, the lower side wave band has a distribution resulting from flipping the frequency distribution in FIG. 6(B) in the lateral direction of FIG. 6.

The data of the frequency distribution in FIG. 6(C), which is generated by the multiplier 13, is supplied to the lower side wave band suppressed HPF 14. The lower side wave band suppressed HPF 14 extracts the frequency components at the set lower limit frequency or greater from the data of the frequency components supplied by the multiplier 13. Thus, data having the frequency distribution shown in FIG. 6(D) is generated.

The data of the frequency distribution shown in FIG. 6(D) generated by the lower side wave band suppressed HPF 14 is supplied to the interpolation component attenuator 15. Further, decoded data to be supplied to the interpolation unit 4 from the decoder 3 is supplied to the main attenuator 16. The interpolation component attenuator 15 and the main attenuator 16 adjust the amplitude of the data entered, and supply the data to the adder 17.

The adder 17 adds the data supplied from the interpolation component attenuator 15 and the data supplied from the main attenuator 16. Thus, the frequency component of the data generated by the lower side wave band suppressed HPF 14 and the frequency component of the decoded data to be supplied to the interpolation unit 4 from the decoder 3 are added. Thus, data having the frequency distribution shown in FIG. 6(E) is generated.

The data having the frequency distribution shown in FIG. 6(E) generated by the adder 17 is supplied to the audio amplifier 5 as interpolation data generated by the interpolation unit 4. The audio amplifier 5 generates an analog audio waveform signal based on the interpolation data, and outputs the signal to the loud speaker 6. The loud speaker 6 generates a sound wave by the supplied analog audio waveform signal. The sound wave that varies according to change in the value of the interpolation data is outputted from the loud speaker 6.

As described above, according to the present embodiment, the interpolation unit 4 generates interpolation data where high frequency components are interpolated into the decoded data supplied thereto.

Further, the higher limit frequencies for reproduction of the reproduction data 7, which is non-reciprocally compressed so as to remove a high frequency component, are lower than the Nyquist frequency. There is a high frequency silent band where there is no frequency component between the higher limit frequency for reproduction and the Nyquist frequency. The high frequency component based on the frequency component of the reproduction data 7 is interpolated into the silent band.

Therefore, the frequency component added to the original sound by the adder 17 is one resulting from only subjecting the frequency components of the reproduction data 7 to frequency shift, which is clear without unnecessary noise component mixed-in. The audio reproduction device 1, which has adopted the interpolation unit 4, can generate audio waveform signals having a favorable waveform with little high frequency distortion, based on the interpolation data in which the high frequency components have been interpolated with components based on the reproduction data 7. The sound wave outputted from the loud speaker 6 has favorable quality with little high frequency distortion. For example, as compared with when the noise component is interpolated, interpolation can be performed so that the sound is in harmony with the reproduction data 7, without generating uncomfortable feeling.

In particular, in the present embodiment, using the band extraction HPF 11 effectively suppresses the frequency components of the portion close to the high frequencies in the lower side wave band, which have been generated as a result of frequency shifting through amplitude modulation by the multiplier 13, as shown in FIG. 6(C). Therefore, while a high-pass filter with few orders and light processing load as the lower side wave band suppressed HPF 14 can be adopted, the frequency components of the lower side wave band are prevented from being mixed with the original sound in the interpolation data after addition by the adder 17.

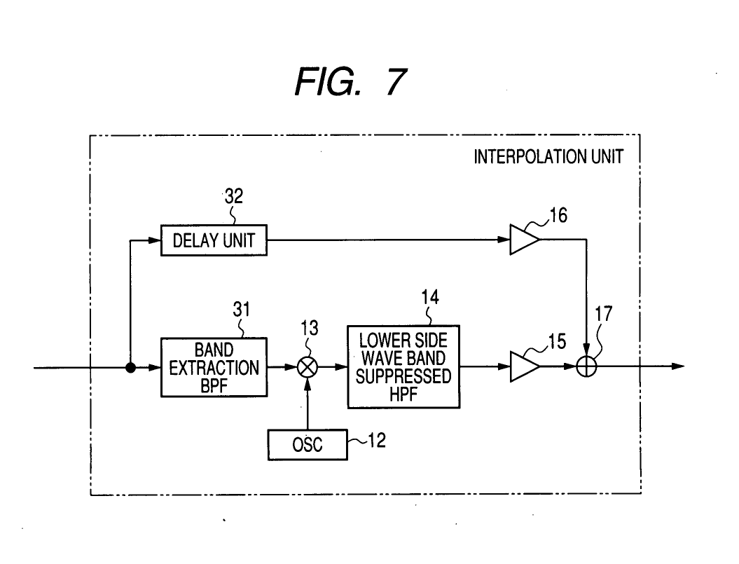

Incidentally, as shown in FIG. 7, even if the band extraction BPF 31 is used in stead of the band extraction HPF 11, the high frequency component based on the original sound (decoded data to be supplied to the interpolation unit 4) can be interpolated into the higher frequency of the original sound. FIG. 7 is a block diagram showing the configuration of the interpolation unit 4 in which a band extraction BPF 31 is used. In FIG. 7, the same symbols are assigned to components having the same function as that of FIG. 1.

However, as shown in FIG. 3, the suppression effect of the low frequency components of the band pass filter is lower than that of the same order high-pass filter. Therefore, as shown by a broken line in FIG. 6(B), when filtering is performed by a 2 order band pass filter, the low frequency component is not sufficiently suppressed than when the 2 order high-pass filter is used for filtering. Accordingly, when the frequency components filtered by the 2 order band pass filter are used to perform multiplication with the multiplier 13, the strength in the lower frequency portion of the higher side wave band and the higher frequency portion of the lower side wave band are greater than when the 2 order high-pass filter is used, as shown by a broken line in FIG. 6(C).

Preferably, the subsequent addition by the adder 17 does not add an unnecessary frequency component such as the lower side wave band to the frequency component of the original sound (decoded data to be supplied to the interpolation unit 4). Therefore, when the strength in the higher frequency portion of the lower side wave band becomes greater as just described, a higher order band pass filter has to be used so as to suppress the lower side wave band more effectively.

Further, when the band pass filter is used for band extraction in this way, as a result, the order of the lower side wave band suppressed HPF 14 has to be increased, thus, the overall order of the combination of the band extraction BPF 31 and the lower side wave band suppressed HPF 14 in FIG. 7 becomes greater than the overall order of the combination of the band extraction HPF 11 and the lower side wave band suppressed HPF 14 in FIG. 1. This difference is about 2 order at the minimum.

In addition, when the FIR filter is used in either of the band extraction BPF 31 or the lower side wave band suppressed HPF 14, group delay occurs resulting from filtering processing. In order to resolve the disturbance of the sound due to the group delay, as shown in FIG. 7, a delay unit 32 has to be provided before the main attenuator 16.

On the other hand, when the band extraction HPF 11 and the lower side wave band suppressed HPF 14 are combined as is the case in the present embodiment, even if the IIR filter is used in both, and even if the overall order thereof is low, for instance, 4 order IIR as in the present embodiment, filtering characteristics for suitably extracting the frequency components in a predetermined band can be obtained. In addition, by using the IIR filter in both, no group delay occurs. A delay unit does not have to be provided before the main attenuator 16.

Further, in the present embodiment, the interpolation component added to the decoded data depends on the higher limit frequency for reproduction of the decoded data to be supplied to the interpolation unit. As a result, the interpolation component can be added without loss of the frequency component of the decoded data to be supplied to the interpolation unit.

In addition, the setting value table 18 divides the higher limit frequencies for reproduction of the decoded data to be supplied to the interpolation unit into a plurality of ranges, and stores a setting value for each range. Thus, the setting value table 18 does not have to store many setting values corresponding to all the reproduction data 7 to be interpolated. The number of the setting values stored by the setting value table 18 can be reduced without reducing the types of interpolatable reproduction data 7.

In particular, in the present embodiment, the higher limit frequencies for reproduction above 8 kHz are divided into five ranges for setting values; 8 kHz or greater but less than 10 kHz, 10 kHz or greater but less than 12 kHz, 12 kHz or greater but less than 14 kHz, 14 kHz or greater but less than 17 kHz, and 17 kHz or greater. With such division of the ranges, no uncomfortable feeling is generated in the sound reproduced after interpolation processing in each range.

Although the embodiment described above is an example of the preferred embodiment of the present invention, the present invention is not limited thereto, and various variations or modifications may be made without departing from the scope of the present invention.

For example, in the embodiment described above, the decoded data to the interpolation unit 4 is directly supplied to the main attenuator 16. In addition to this, a delay unit may be provided before the main attenuator 16, for example.

Although, in the embodiment described above, the band extraction HPF 11 has been used, this only needs the characteristics of attenuating frequency components of a predetermined frequency or less, and the property need not be complete “extraction”.

In the embodiment described above, the parameter setting unit 19 performs setting according to the sampling frequency and bit rate of the decoded data to be supplied to the interpolation unit 4. In addition to this, for example, the parameter setting unit 19 may perform setting according to whether or not the decoded data to be supplied to the interpolation unit is music data, or according to the type of the music. Information about the type of the music can be obtained from tag data corresponding to the reproduction data 7, for example.

In the embodiment described above, the decoder 3 generates the decoded data to be supplied to the interpolation unit 4 from the reproduction data 7 to be stored in the hard disk drive 2 in the audio reproduction device 1. In addition to this, for example, the decoder 3 may generate the decoded data to be supplied to the interpolation unit 4 from the reproduction data 7 obtained through a communication line.

In the embodiment described above, the decoded data generated by the decoder 3 is supplied to the interpolation unit 4. In addition to this, for example, data obtained by digitizing audio waveform signals may be supplied from an electric musical instrument, an FM radio, an AM radio, a television receiver, AV equipment or the like.

### INDUSTRIAL APPLICABILITY

The present embodiment may be used in a portable hard disk player or the like that reproduces sound.

1. An interpolation device comprising:
a band extraction high-pass filter adapted to extract frequency components at a predetermined lower limit frequency or greater from reproduction data obtained by digitizing an audio waveform signal;
a multiplier adapted to subject the frequency components extracted by the band extraction high-pass filter to frequency shift;
a lower side wave band suppressed high-pass filter adapted to suppress the frequency components in a lower side wave band in the frequency components subjected to frequency shift by the multiplier; and
an adder adapted to add the frequency components after suppression by the lower side wave band suppressed high-pass filter to the frequency components of the reproduction data.

2. The interpolation device according to claim 1, wherein
the band extraction high-pass filter and the lower side wave band suppressed high-pass filter are made up of an IIR filter, and
the reproduction data to be supplied to the band extraction high-pass filter is supplied to the adder without delay.

3. The interpolation device according to claim 1 or 2 comprising:
a setting value table adapted to store setting values according to higher limit frequencies for reproduction of the reproduction data to be supplied to the band extraction high-pass filter;
a specifying unit adapted to specify a higher limit frequency for reproduction of the reproduction data to be supplied to the band extraction high-pass filter; and
setting means for reading a setting unit adapted to read thereinto, from the setting value table, the setting value corresponding to the higher limit frequency for reproduction specified by the specifying means unit, and setting a predetermined lower limit frequency of the band extraction high-pass filter, the width of the frequency shift by the multiplier, and frequency components suppressed by the lower side wave band suppressed high-pass filter.

4. The interpolation device according to claim 1 or 2 comprising:
a setting value table adapted to store a setting value for each range of higher limit frequencies for reproduction of the reproduction data to be supplied to the band extraction high-pass filter;
a specifying unit adapted to specify a higher limit frequency for reproduction of the reproduction data to be supplied to the band extraction high-pass filter; and
a setting unit adapted to read thereinto, from the setting value table, the setting value in a range including the higher limit frequency for reproduction specified by the specifying unit, and setting a predetermined lower limit frequency of the band extraction high-pass filter, the width of the frequency shift by the multiplier, and frequency components suppressed by the lower side wave band suppressed high-pass filter.

5. The interpolation device according to claim 4, wherein
the ranges of the higher limit frequencies for reproduction of the reproduction data above 8 kHz in the setting value table are 8 kHz or greater but less than 10 kHz, 10 kHz or greater but less than 12 kHz, 12 kHz or greater but less than 14 kHz, 14 kHz or greater but less than 17 kHz, and 17 kHz or greater.

6. An audio reproduction device comprising:
the interpolation device according to claim 1 or 2; and
a decoder adapted to supply reproduction data having a higher limit frequency for reproduction that is lower than the Nyquist frequency to the interpolation device.

7. An audio reproduction device comprising:
the interpolation device according to claim 1 or 2; and
a decoder adapted to generate from reproduction data, which is non-reciprocally compressed so that high frequency components are removed, the reproduction data to be supplied to the interpolation device.

8. An interpolation method comprising the steps of:
extracting frequency components at a predetermined lower limit frequency or greater from reproduction data obtained by digitizing an audio waveform signal;
subjecting the extracted frequency components to frequency shift;
suppressing the frequency components in a lower side wave band in the frequency components subjected to frequency shift; and
adding the frequency components after the suppression to the frequency components of the reproduction data.

9. An interpolation program that causes a computer to execute the steps of:
extracting frequency components at a predetermined lower limit frequency or greater from reproduction data obtained by digitizing an audio waveform signal;
subjecting the extracted frequency components to frequency shift;
suppressing the frequency components in a lower side wave band in the frequency components subjected to frequency shift; and
adding the frequency components after the suppression to the frequency components of the reproduction data.
